(19) United States
(12) Patent Application Publication
(10) Pub. No.: US 2005/0030643 A1
(43) Pub. Date: Feb. 10, 2005

(54) Spherical view imaging apparatus and method

(76) Inventors: Ehud Gal, Reut (IL); Gennadiy Liteyga, Ashkelon (IL); Reuven Eyal, Ramat HaSharon (IL)

Correspondence Address: MARSTELLER & ASSOCIATES, P O BOX 803302, DALLAS, TX, 75380-3302, US

(21) Appl. No.: 10/470,226

(22) PCT Filed: Jan. 24, 2002
(86) PCT No.: PCT/IL02/00074

Related U.S. Application Data
(60) Provisional application No. 60/264,009, filed on Jan. 26, 2001.
(60) Provisional application No. 60/276,933, filed on Mar. 20, 2001.
(60) Provisional application No. 60/322,737, filed on Sep. 18, 2001.

(51) Int. Cl. G02B 13/06

(52) U.S. Cl. 359/725

(57) ABSTRACT

An imaging apparatus which comprises: an axisymmetric form comprising a transparent lateral surface, a first end (6) surface, and a second end (7) surface; a first lens positioned substantially perpendicular to and concentric with the axis of the axisymmetric form to the side of the first end surface; a second lens positioned substantially perpendicular to and concentric with the axis of the axisymmetric form, to the side of the second end surface; and an image acquiring device positioned substantially coaxially with the second lens and beyond the second lens with respect to the second end surface. The imaging apparatus is a spherical view (48) imaging apparatus.

### FIELD AND BACKGROUND OF THE INVENTION

The present invention relates to a spherical view imaging apparatus and method wherein images can be sensed in a neatly full spherical field of view. More particularly but not exclusively the invention relates to spherical view image forming and spherical view sensing.

One basic type of spherical view imaging apparatus comprises simultaneous and synchronized photography from multiple cameras, with each camera covering only part of the full field of view (FOV).

Another example of prior art spherical view imaging comprises an existing single-camera system, disclosed in U.S. Pat. No. 6,028,719, the contents of which are hereby incorporated by reference. The system operates by covering nearly a full spherical FOV. The prior art single-camera system, however, suffers from a number of deficiencies, namely: the image produced by the camera system includes a discontinuity that must be resolved using computerized methods; vertical resolution at higher elevation angles is relatively poor and; system design limits the physical size of the device so that it cannot be applied to very small tubes or closed spaces.

Observation devices available in the market today provide compromises between FOV and magnification. Thus, for high magnification, a device is limited in its achievable field of view, and if FOV is important, then devices are limited in magnification power. Existing spherical view photography today relies on methods which are cumbersome, are expensive, and are maintenance intensive.

The apparatus and method in the present application address the limitations discussed above.

### SUMMARY OF THE INVENTION

According to a first aspect of the present invention there is thus provided an imaging apparatus comprising:
a. An axisymmetric form comprising a transparent lateral surface, a first end surface, and a second end surface.
b. A first lens positioned substantially perpendicular to and concentric with the axis of said axisymmetric form, to the side of said first end surface.
c. A second lens positioned substantially perpendicular to and concentric with the axis of said axisymmetric form, to the side of said second end surface.
d. An image acquiring device positioned substantially coaxially with said second lens and beyond said second lens with respect to said second end surface;
thereby to form a nearly spherical image at said image acquiring device.

Preferably said second end surface is symmetrically concave and comprises a reflecting layer and a transparent, non-reflecting central circular segment, said segment being located to allow light to pass primarily axially through said central circular segment and through said axisymmetric form.

Preferably said first end surface comprises a circular reflective layer with a transparent, non-reflective central circular area, said non-reflective central circular area being located to allow light to pass substantially axially through said axisymmetric form and through said central circular segment.

Preferably said circular reflective layer is substantially flat.

Preferably said second end surface and said first end surface are mutually configurable to enable light from at least one object located substantially lateral to said axisymmetric form to pass into said axisymmetric form, to reflect from said second end surface, then to pass within said axisymmetric form and to reflect from said first end surface, and then to pass through said central circular segment in said second end surface.

Preferably said first lens comprises a plurality of lenses.

Preferably said first lens is located with respect to said axisymmetric form to enable light from an object located substantially axially exterior from said first end surface to be focused onto said image acquiring device.

Preferably said second lens comprises a plurality of lenses.

Preferably said second lens is configured to enable focusing of light passing from said axisymmetric form through said central circular segment, onto said image acquiring device.

Preferably said image acquiring device is a camera.

Preferably said first end surface comprises a circular reflective layer with a transparent, non-reflective central circular area, said non-reflective central circular area being located to allow light to pass substantially axially through said axisymmetric form and through said central circular segment to said image acquiring device, and wherein said second end surface and said first end surface are mutually configurable to enable light from at least one object located substantially lateral to said axisymmetric form to pass into said axisymmetric form, to reflect from said second end surface, then to pass within said axisymmetric form and to reflect from said first end surface, and then to pass through said central circular segment in said second end surface to said image acquiring device, thereby yield an uncorrected image of substantially circular shape comprising a central image part and a toroidal image part.

Preferably said first end surface is substantially flat.

Preferably said first end surface is substantially convex.

Preferably said first end surface is substantially concave.

Preferably said central image part comprises direct light from objects located primarily axially to said axisymmetric form and wherein said toroidal image part comprises doubly reflected light from objects located primarily laterally to said axisymmetric form.

Preferably details of said central image part and said toroidal image part are of the same orientation.

Preferably further comprising an image transformer for transforming said uncorrected image into a predetermined format for viewing.

Preferably said predetermined format is at least one from a list comprising rectangular, cylindrical, and spherical formats.

Preferably said first lens is incorporated into said first end surface.

Preferably said image acquiring device comprises an optical filter and a light sensing device, and wherein said optical filter is positioned before said light sensing device.

Preferably said light sensing device is a focal plane array.

Preferably said focal plane array is a CCD.

Preferably said transparent lateral surface is transparent for at least one predetermined wavelength.

Preferably said first lens is transparent for at least one predetermined wavelength.

Preferably said axisymmetric form and said lenses are manufactured from any one of a group of materials comprising optic glass and optic plastic, said materials being selected to ensure optical properties including transparency, homogeneity, and index of refraction.

Preferably said concave symmetrical surface is chosen from a family of axisymmetric shapes defined by rotating a curve around an axis of symmetry.

Preferably said concave symmetrical surface is a hemisphere.

Preferably said concave symmetrical surface is a paraboloid.

Preferably said concave symmetrical surface is a cone.

Preferably said axisymmetric form is chosen from a family of axisymmetric shapes defined by rotating any one of a plurality of curves around an axis of symmetry.

Preferably said axisymmetric form is a cylinder.

Preferably said axisymmetric form is a sphere.

Preferably said axisymmetric form is a spheroid.

Preferably said axisymmetric form is either one of a group chosen from a list of variant cylindrical forms comprising a cylinder with a convex lateral surface and a cylinder with a concave lateral surface.

Preferably said axisymmetric form comprises a hollow axisymmetric shape.

Preferably a wall thickness of said hollow axisymmetric shape is chosen to ensure predetermined diffraction coefficient properties.

Preferably material of said hollow axisymmetric shape is chosen to ensure predetermined wavelength selectivity.

Preferably at least one of said first surface and said second surface is removably attached to said hollow axisymmetric shape.

Preferably said axisymmetric form comprises a hollow axisymmetric shape and said reflective layer comprises a reflective coating interior to said hollow axisymmetric shape.

Preferably said axisymmetric form comprises a hollow axisymmetric shape and said reflective layer comprises a reflective coating exterior to said hollow axisymmetric shape.

Preferably said axisymmetric form comprises a hollow axisymmetric shape and said reflective layer comprises a reflective coating interior to said hollow axisymmetric shape.

Preferably said axisymmetric form comprises a hollow axisymmetric shape and said reflective layer comprises a reflective coating exterior to said hollow axisymmetric shape.

Preferably said axisymmetric form comprises a solid monolithic form.

Preferably said solid monolithic form is constructed of a material to ensure predetermined wavelength selectivity.

Preferably said solid monolithic form is constructed of a material to ensure predetermined diffraction coefficient properties

Preferably respective reflective surfaces comprise reflective coatings applied exterior to said solid monolithic form.

Preferably said image light sensing device is controllably connected to a registration controller to enable radial and axial registration of a detected illuminator source relative to said axisymmetric form.

Preferably further comprising a source location mechanism, associated with said controller, operable to align said imaging acquiring device with true north and to translate said radial and axial registration into azimuth and elevation information.

Preferably said source location mechanism is further operable to; Move said imaging acquiring device a known distance from an initial location to a new location.

Set said imaging acquiring device to view said illuminator source.

To determine new location azimuth and elevation information; thereby to determine a range of an illumination source.

Preferably said source location mechanism further comprising a triangulation device to triangulate said illuminator source range using said initial location and said new location azimuth and elevation information with said determined range, thereby to determine a location of said illuminator source.

Preferably a range of said illuminator source is determinable using a range finder positionable in substantially close proximity to said imaging acquiring device.

According to a second aspect of the present invention there is thus provided a spherical illuminator source location apparatus comprising two illuminator detection devices respectively comprising;
a. An axisymmetric form comprising a lateral surface, a first end surface, and a second end surface.
b. A first lens positioned substantially perpendicular to and concentric with the axis of said axisymmetric form, to the side of said first end surface.
c. A second lens positioned substantially perpendicular to and concentric with the axis of said axisymmetric form, to the side of said second end surface.
d. An image acquiring device positioned substantially coaxially with said second lens and beyond said second lens with respect to said second end surface.

Preferably said apparatus further comprising a controller, operatively connected to each illuminator detection device, to coordinate measurements of respective illuminator detection devices of an illuminator source to determine a location of said illuminator source.

Preferably respective illuminator detection devices are positionable a fixed distance from each other for viewing an illuminator source.

Preferably said controller is operable to coordinate registering respective radial and axial coordinates of said illuminator source; to align respective initial coordinates with true north; to translate said respective radial and axial coordinates into respective azimuth and elevation information; and to triangulate using said fixed distance, and respective azimuth and elevation information to obtain a range of said illuminator source.

According to a third aspect of the present invention there is thus provided a method for measuring a direction of an illumination source comprising,
a. Imaging said illumination source, within a spherical view, using a unified optical apparatus.
b. Registering radial and axial coordinates of said illumination source.
c. Aligning with true north.
d. Translating said radial and axial coordinates into azimuth and elevation information.

Preferably comprising determining a range of said illumination source by;
a. Moving a known distance from an initial measuring location to a new location.
b. Imaging said illumination source, within a spherical view, using a unified optical apparatus.
c. Registering new radial and axial coordinates of said detected illumination source.
d. Aligning initial coordinates of the new location with true north.
e. Translating said new radial and axial coordinates into new azimuth and elevation information.
f. Triangulating by using said new azimuth and elevation information, said initial location determined azimuth and elevation information, and said known distance.

Preferably comprising determining said illumination source range using a rangefinder located substantially adjoining said unified optical apparatus to measure a range to said illuminator source.

### BRIEF DESCRIPTION OF TEE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A is a schematic representation of the main components of an imaging system operative in accordance with a first preferred embodiment of the present invention;

FIG. 1B is a schematic representation of the optical paths of the imaging system of FIG. 1A;

FIG. 1C is a schematic representation of FOV sectors covered by the imaging system of FIG. 1A;

FIG. 2A is a representation of a doughnut-shape view of an acquired image;

FIG. 2B is a rectangular projection of the nearly spherical view of FIG. 2A;

FIG. 3 is a schematic representation of a doughnut-shape of an acquired mage;

FIG. 4A is a schematic representation of a full spherical view to be imaged;

FIG. 4B is a schematic representation showing a comparison between acquisition of an image by embodiments of the present invention and by the prior art;

FIG. 5A is a schematic representation of an alternate configuration of a spheroid form of imaging system, according to the preferred embodiment indicated in FIG. 1A;

FIG. 5B is a schematic representation of an alternate upper surface configuration, derived from that shown in FIG. 5A;

FIG. 6 is a schematic representation of an alternate configuration of cylindrical variant forms of imaging system, according to the preferred embodiment indicated in FIG. 1A;

FIG. 7 is a schematic representation of a two-dimensional configuration of an imaging system and an illumination source;

FIG. 8 is a schematic representation of a second imaging system and the illumination source;

FIG. 9 is a schematic representation of a two-dimensional configuration of initial and second imaging systems and the illumination source;

FIG. 10 is a schematic representation of one imaging system moved to a second location and viewing an illumination source;

FIG. 11 is a schematic representation of two imaging systems with a controller viewing an illumination source; and

FIG. 12 is a schematic representation of one imaging system and a rangefinder viewing an illumination source.

### DESCRIPTION OF THE PREFERRED EMBODIMENTS

The preferred embodiment provides spherical view image gathering for a nearly 360 degree spherical field of view using a single optical assembly. More particularly, images can be sensed in a nearly full spherical field of view by utilizing a combination of two or more matched reflective surfaces along with matched optical elements in a unified configuration and structure.

Before explaining the embodiments of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

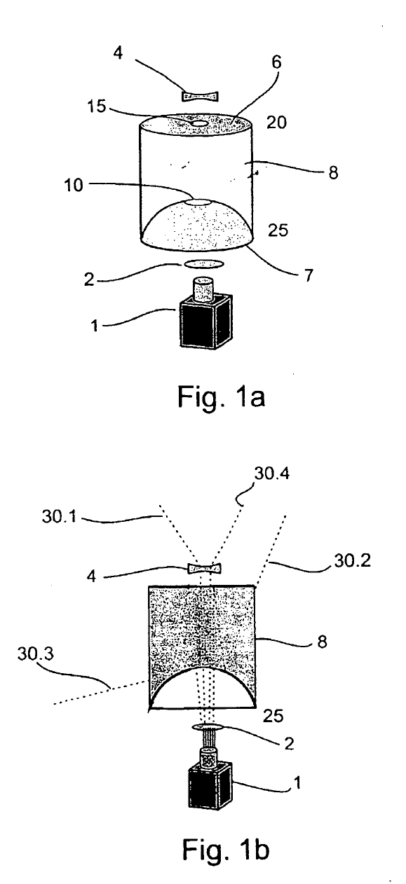

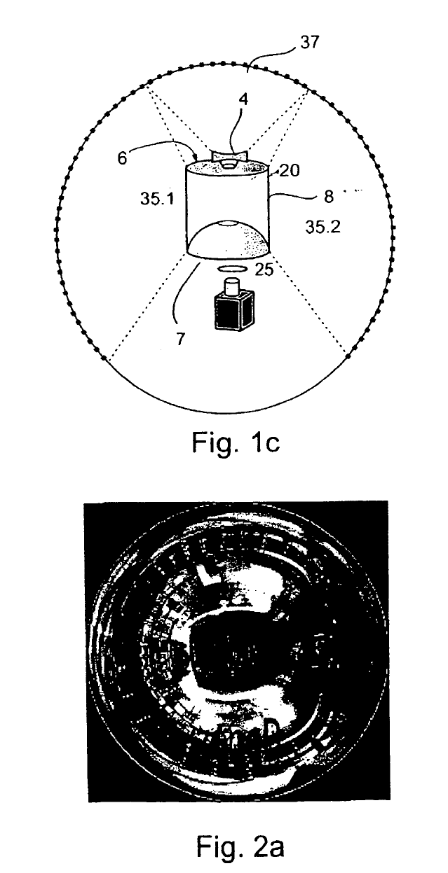

Reference is now made to FIG. 1A, which is a simplified representation of the main components of an imaging system according to a first preferred embodiment of the present invention.

A transparent cylindrical form 8 has a concave base 25 and a flat upper surface 20, both of which are reflectively coated. Transparent circular areas 10 and 15 are maintained in the center of the reflective coatings of the concave base 25 and a flat upper surface 20, respectively. The transparent cylindrical form 8 has two ends indicated as first end 6 and second end 7. A camera 1 is placed coaxially externally of the second end 7, and a lower lens 2 is positioned between the camera 1 and the cylindrical form 8. An upper lens 4 is located to the coaxially externally of the first end 6. The camera 1 may represent a fixed optical device or an integrated electronic/optical device composed of lenses, filters, and a focal plane array (FPA) such as a CCD.

It should be noted that the transparent cylindrical form 8 may be either one solid piece of transparent material or it may be a type of transparent cylindrical hollow housing where the concave base 25 and a flat upper surface 20 are fitted onto the cylindrical housing. In the first option, reflective coatings noted above are external. In the second option, reflected coatings may be on internal surfaces.

The configuration shown in FIG. 1A allows light from images located laterally (i.e. perpendicular to the cylinder axis) to the cylindrical form 8 to enter the lateral sides of the cylindrical form 8 and be reflected from the concave base 25 and onto the flat upper surface 20, then to the lower lens 2 and to the camera 1. Light from images from the first end 6 and longitudinal to the cylindrical form 8 enters the upper lens 4, and is focused through the cylindrical form 8 and through the lower lens 2 to the camera 1.

Reference is now made to FIG. 1B which is a simplified schematic diagram showing the optical paths for the imaging system, as previously described in FIG. 1A. Light follows optical paths 30.1 and 30.4 from the side of the first edge 6, and optical paths 30.2 and 30.3 from the lateral surfaces of the cylindrical form 8. It should be noted that light from images located nearly coaxially to the cylindrical form 8 and to side of the second edge 7, i.e. from the direction of the camera 1, are not captured by the imaging system.

Reference is now made to FIG. 1C, which is a schematic representation of FOV sectors, i.e. portions of a nearly 360° spherical FOV seen by specific component of the system, covered by the imaging system. Lateral FOV sectors 35.1 and 35.2 represent the FOV covered by the concave base 25. Upper axial FOV sector 37 represents the FOV covered by the upper lens 4. It is appreciated that the lateral FOV sectors 35 extend radially around the cylindrical form 8, whereas the upper longitudinal FOV sector 37 extends in a solid conical fashion outwards from the first edge 6. It can be seen from FIG. 1C that a nearly spherical image is preferably acquired in sectors, each sector preferably covering a different part of the overall sphere. A nearly spherical image from the sectors noted above is acquired simultaneously, due to the imaging system configuration. As opposed to this, it should be noted that in the prior art, piecing together of multiple FOV sectors to form a continuous image is typically performed using conventional optical and/or digital techniques.

Images acquired and produced by the current embodiment, as described in FIGS. 1A, 1B, and 1C, are now described to better illustrate full spherical imaging. It should be noted that although the systems shown in FIGS. 1A, 1B, and 1C indicate a vertical orientation of the cylindrical form 8 and associated components, the systems shown may also be configured in other orientations depending on the application.

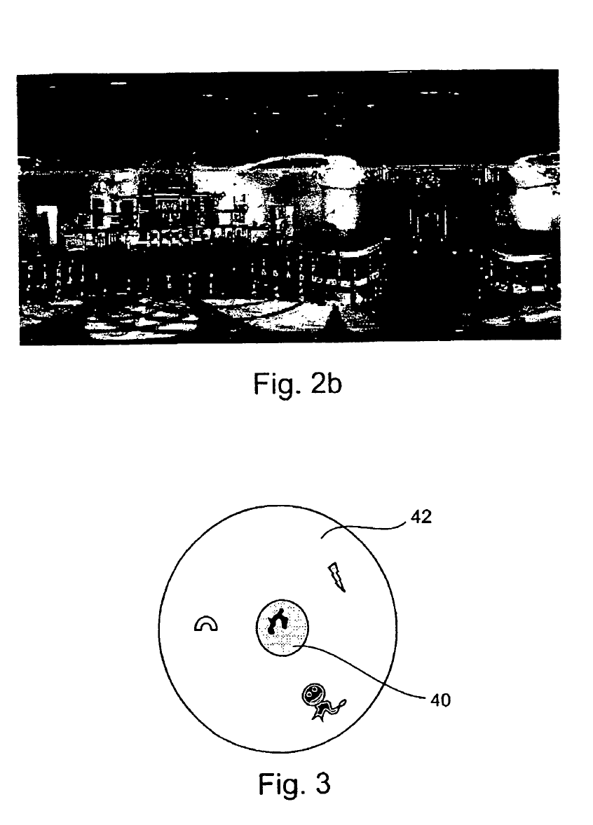

Reference is now made to FIG. 2A which shows a doughnut-shaped view representing an actual acquired image of a nearly spherical view of a landscape captured in one frame, including distortions, using the present embodiment. The term ‘doughnut’ is used because in the present figure the region in the center of the image is designated as Zone A whereas the toroidal region in the image is indicated as Zone B. The significance of these two zones becomes clear when referring to the image shown in FIG. 2B, below. Reference is now made to FIG. 2B, which is a nearly spherical view of the same landscape shown in FIG. 2A projected onto a rectangular surface. The area along the top of the rectangular projection is designated as Zone A and it corresponds to the similarly designated area in FIG. 2A. Likewise, the area representing roughly ⅔ of the bottom of the rectangular projection is designated Zone B, corresponding to the similarly designated area in FIG. 2A. As noted before, the image shown in FIG. 2B is based on the view as shown in FIG. 2A. The distortions of the image shown in FIG. 2A are corrected by an image transformer-preferably an image processor.

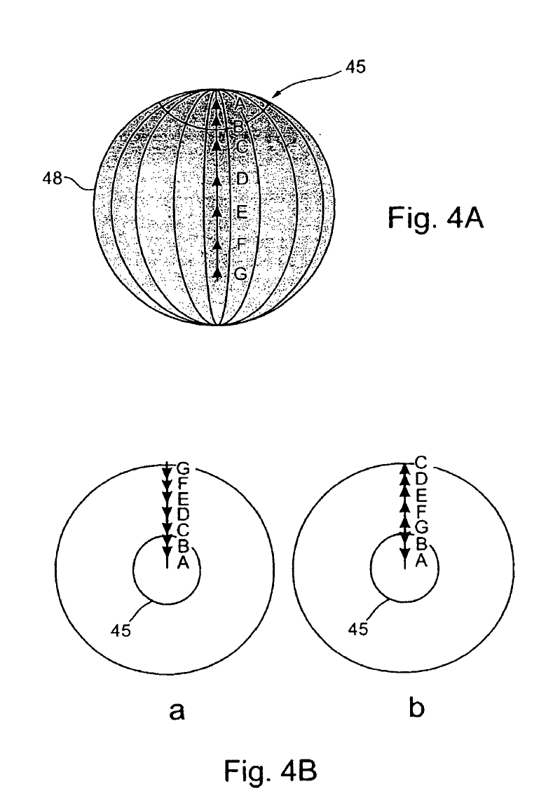

To better understand how the two zones (Zone A and Zone B) are formed and how the problems apparent with prior art are addressed in the present patent application, reference is now made to FIG. 3 which shows a schematic representation of a doughnut shape of an acquired image. The center region 40 comprises images acquired by the upper lens 4, as indicated in FIGS. 1A and 1B, whereas the toroidal region 42 comprises images acquired by the reflective concave base 25, as indicated in FIGS. 1A and 1B. The center region 40 and toroidal region 42 are similar to the regions previously designated in FIGS. 2A and 2B as Zone A and Zone B, respectively. Those skilled in the art will note that there is a discontinuity in the acquired image, as represented in the present figure. The discontinuity is due to the border between images acquired either from the upper lens or from the concave base, as previously noted. The discontinuity is formed at the border between the center region 40 and the toroidal region 42 as noted in FIG. 4. The center region 40, toroidal region 42, and the discontinuity noted above are further amplified, as described below.

Reference is now made to FIG. 4A which shows a schematic representation of a full spherical view 48 that is intended to be imaged from the inside. The letters A through G in the present figure, accompanied with directional arrows, represent relative positions and the sense (up or down in this case) of objects along a longitudinal line drawn in the spherical view 48. The letters A through G are arranged sequentially starting approximately at the pole of spherical view 48 and extending to beneath the equator. A circle 45 indicates a line along which discontinuity between lateral and axial portions of the resultant acquired image may occur, as discussed below.

Reference is now made to FIG. 4B which shows two image representations: (a) an image acquired with the present invention and: (b) an image acquired with the prior art. The letters and arrow directions in the present figure are analogous to those indicated in FIG. 4A. The circle 45 indicates the line along which discontinuity between lateral and axial portions of the resultant acquired image may occur, analogous to the circle 45 indicated in FIG. 4A. Note in the present system image (a) that all points on the full spherical view 48 (corresponding to FIG. 4A) are in the correct sequence (ABCDEFG) and have the same sense. However, in the prior art image (b) the points CDEFG are not only imaged in the incorrect order, but also in a different sense (inverted) than the points AB within the circle 45. The noted inversion is due to the fact that in the prior art, only one reflective surface is utilized. The present embodiments employ a combination of direct image acquisition, yielding the region within circle 45, and two reflecting surfaces which yield the toroidal region outside of circle 45. Referring once again to FIG. 1A, the combination of direct image acquisition through the upper lens 4 with double reflection obtained from the concave base 25 and the flat upper surface 20 in the current invention, preserves a consistent sense of all FOV sectors and avoids the sense inversion characteristic of the prior art.

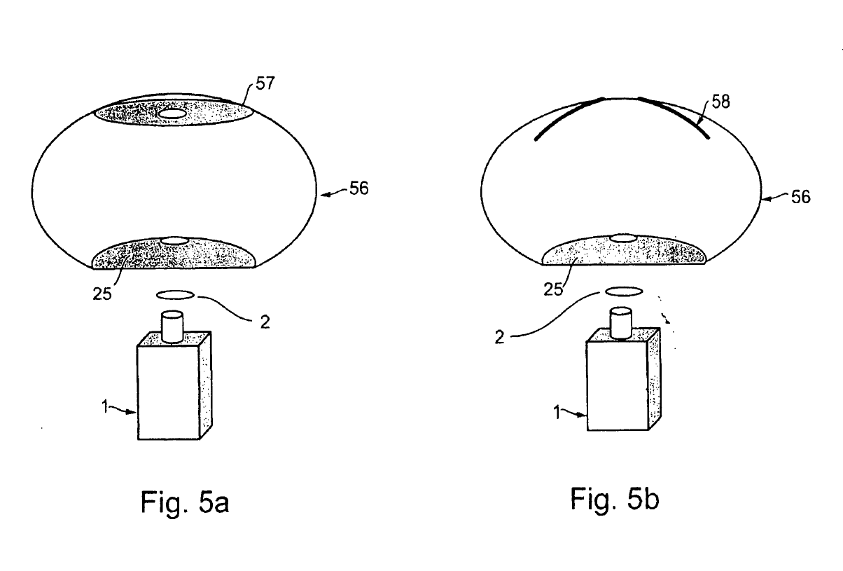

In addition to a transparent cylinder shape, a number of alternate imaging system shapes may be used to enable the above-mentioned combination of direct and double reflection image acquisition. Reference is now made to FIG. 5A, which is a schematic representation of an alternate configuration of a spheroid form of imaging system, according to the preferred embodiment indicated in FIG. 1A. A transparent spheroid form 49 has a concave base 50 and a flat upper surface 52, both of which are reflectively coated. Transparent circular areas 53 and 54 are maintained in the center of the reflective coatings of the concave base 50 and a flat upper surface 52, respectively. The configuration of transparent circular areas 53 and 54 is analogous to that of the circular areas 10 and 15 shown in FIG. 1A with the exception that the upper lens 4 of FIG. 1A is integrated into the transparent circular area 54. A transparent circular area with a non-integrated lens, such as indicated in FIG. 1A may also be employed. Those skilled in the art will appreciate that the transparent spheroid form 49 may represent a family of shapes, ranging from an elongated spheroid to a near sphere to a squat spheroid shape.

Reference is now made to FIG. 5B, which is a schematic of an alternate upper surface configuration, based on the similar spheroid form of FIG. 5A. An upper surface 55 is shown on its edge. The upper surface 55 is similar to the flat upper surface 52 shown in FIG. 5A. However, in the present figure, the upper surface 55 may be curved with a curvature matching the spheroid or with another curvature, based on the desired optics and focusing effects. It is noted by those skilled in the art that the upper surface 55 may be used with an integrated upper lens, as noted in FIG. 5A. Furthermore, a similar curved upper surface may also be employed with any imaging system forms.

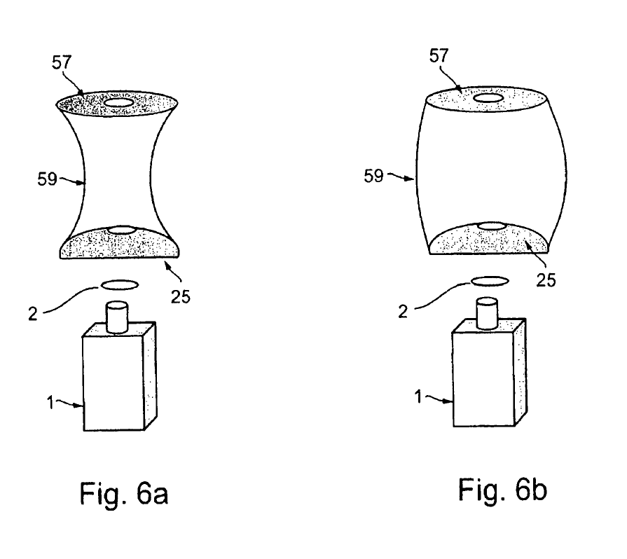

Reference is now made to FIG. 6 which is a schematic representation of cylindrical variant forms of an imaging system. Parts that are the same as those in previous figures are given the same reference numerals and are not described again except as necessary for an understanding of the present embodiment. Referring to the first image (a), a cylindrical variant form 59 has a concave base 25 and a flat upper surface 57, both of which are reflectively coated. Those skilled in the art will appreciate that the cylindrical variant form 59 may represent a family of shapes, ranging from the narrow-waisted hourglass form as shown in (a), to a straight cylinder of the kind shown in FIG. 1A to a cylindrical form having a convex or outwardly bulging lateral wall as shown in the present figure, (b).

As previously noted, all of the other variant forms indicated above may be fabricated either from one solid piece of transparent material or they may be made of a type of transparent hollow housing where respective concave bases and upper surfaces are fitted onto the hollow housing.

The material chosen to fabricate any of the above-mentioned shapes (be they solid or hollow) may be to enable and/or enhance refraction and for other optical enhancements and corrections of aberrations. In the case of a hollow shape, the wall thickness of the material may be likewise selected to enable and/or enhance refraction and for other optical enhancements and corrections of aberrations. In addition, whether in a solid or hollow form, the form material and lens material may be chosen to act as a filter, meaning the material may be transparent to one or more wavelengths and opaque or partially opaque to other wavelengths.

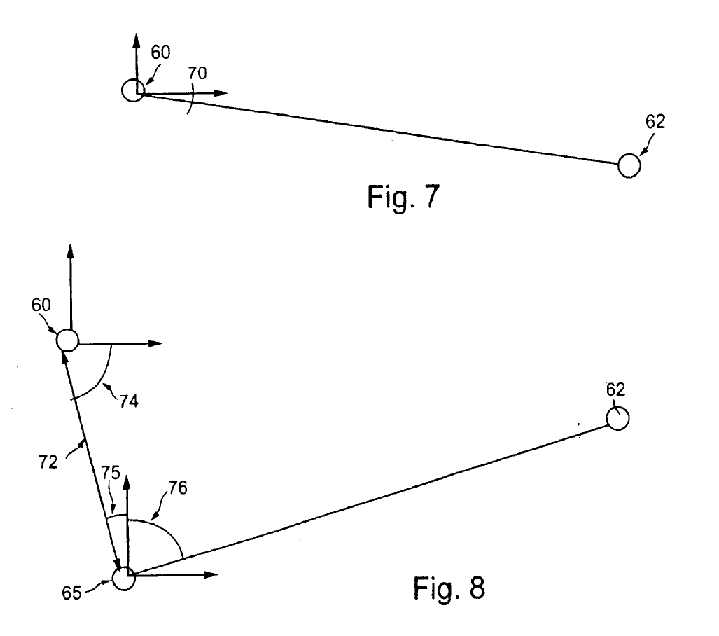

The following discussion, including FIGS. 7, 8, and 9, provides a background for determining azimuth, elevation, and range information for an illuminator source viewed by an imaging system. Reference is now made to FIG. 7 which is a simplified schematic diagram showing a two-dimensional configuration of an imaging system 60 viewing an illuminator source 62. The imaging system 60 is preferably positioned relative to a known coordinate system, having been aligned with a fixed reference, true north. The illumination source 62, as viewed from the imaging system 60, is displaced by an angle 70 relative to a reference direction in the coordinate system. As a result, the displacement angle 70 may be readily measured. Those skilled in the art will appreciate that angles can similarly be measured in 3 dimensions.

Reference is now made to FIG. 8, which is a simplified diagram showing a second imaging system and the illuminator source. Note that some elements previously shown in FIG. 7 are repeated for clarity in FIG. 8. In FIG. 8 a second imaging system 65 is located a known distance 72 from the initial imaging system 60. The second imaging system 65, as viewed from the initial imaging system 60 is displaced by an angle 74 relative to the reference direction noted in FIG. 7. The second imaging system 65 is aligned with a fixed reference, preferably using the same coordinate system as noted in FIG. 7. In a manner similar to that noted in FIG. 7, an angle 75 of the initial imaging system 60 relative to the second imaging system 65 may be readily measured. Likewise, an angle 76 of the illuminator source 62 relative to the second imaging system 65 may be readily measured. In this case, once again, angles in a third dimension may be measured similarly.

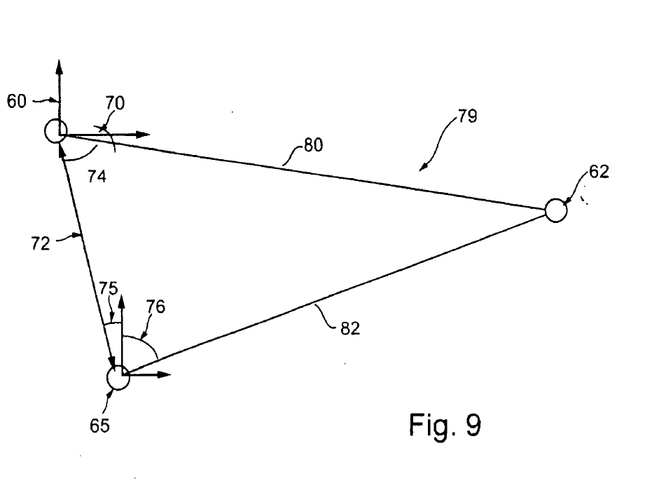

Reference is now made to FIG. 9, which is a simplified schematic diagram showing a two-dimensional configuration of the initial imaging system 60, the second imaging system 65, and the illuminator source 62. A triangle 79 is created by the initial imaging system 60, second imaging system 65, and the illuminator source 62. Angles 70, 74, 75, and 76 are known—having preferably been measured as described above. As a result, the internal angles of the triangle 79 respectively at initial imaging system 60 and at the second imaging system 65 may be determined. Furthermore, as previously noted, the distance 72 between the initial imaging system 60 and the second imaging system 65 is known. Therefore, a classic triangulation configuration exists. Those skilled in the art will appreciate that ranges 80 and 82 to the illuminator source 62, respectively, may be readily calculated and that this calculation can be performed in three dimensions, as well. As a result, the measured angular information, combined with one distance—in this case, the known distance between the two measuring points—an be used to yield azimuth, elevation, and range information for an illuminator source viewed by one imaging system in two locations or two imaging systems in two separate locations.

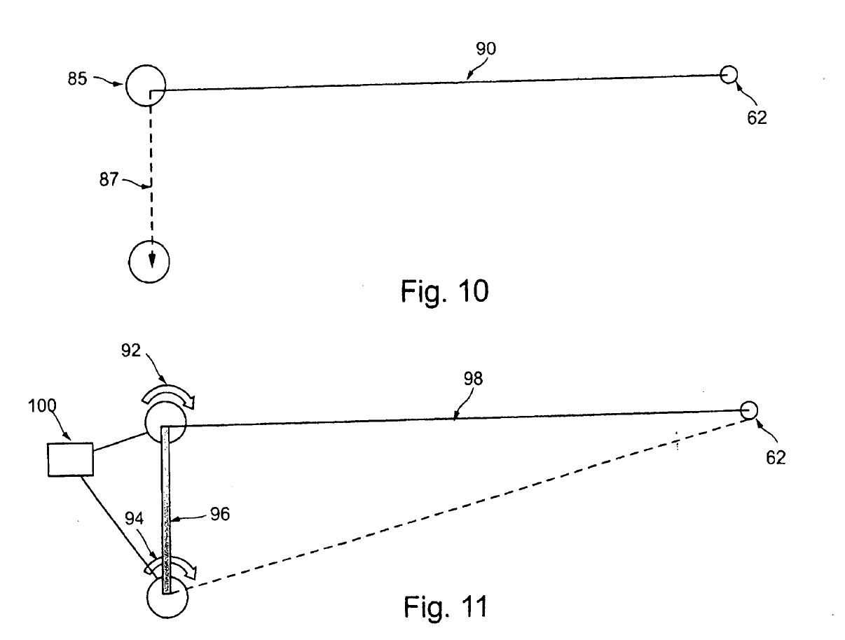

While angular information to an illumination source, yielding azimuth and elevation, may be measured directly using one imaging system, as previously discussed, range information must be obtained by triangulation, as described in FIG. 9 above. Range may be determined in any of the three ways as described below. Note that although the following FIGS. 10, 11, and 12 show two-dimensional configurations, those skilled in the art can readily extend the concepts to range calculation based on three dimensions.

Reference is now made to FIG. 10, which is a schematic representation of an imaging system 85 viewing an illumination source 62. Once the illumination source 62 is viewed and angles are measured, as previously described in FIGS. 7, 8, and 9, the imaging system 85 is moved a fixed distance 87 whereupon the illumination source 62 is again viewed and angles are again measured. In this case, range 90 to the illumination source is obtained using one imaging system 85. This is accomplished by obtaining angular two positions to triangulate range 90.

Reference is now made to FIG. 11 which is a schematic representation of two imaging systems 92 and 94, respectively viewing an illumination source 62. A bridge mechanism 96 whose exact length is known, links imaging systems 92 and 94 together. Imaging system 92 views the illumination source 62 at a range 98 whose value will be determined. In this case, a controller 100, coordinates aiming of the respective imaging systems 92 and 94 and combines measured angles, as described above in FIG. 10, along with the bridge mechanism 98 length, to triangulate the range 98 to the illumination system.

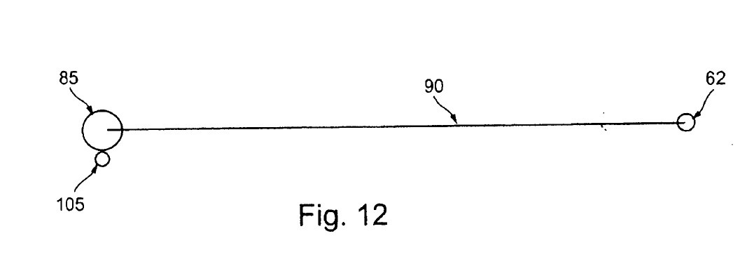

Reference is made to FIG. 12 which is a schematic representation of one imaging system 85 viewing an illumination source 62 at a range 90, whose value is to be determined. A rangefinder 105 is placed preferably adjoining the imaging system and range 90 is measured. In this case, only one imaging system 85 is employed and the rangefinder 105, preferably a commercially available device yielding a range 90 value.

In each of the embodiments of FIGS. 10 to 12, the ability to capture illumination from an illumination source and to control and coordinate the measurement of individual pixels acquired by the camera of an illuminator source enables determination of angular coordinates between an imaging system and an illumination source. An electronic controller is typically employed to perform the above-described coordination of acquired pixels to determine angular coordinates. Once angular coordinates have been obtained, as previously noted, azimuth, elevation, and then range information can be obtained by triangulation.

The concave reflecting surface noted in embodiments of the present invention represents a full family of axisymmetrical reflectors. The cross section along the axis of symmetry of the concave base 25 reflective surface of FIG. 1A may take the shape of a triangle (expressed as a cone), a parabola (expressed as a paraboloid), a hyperbola, or any specific shape optimized for specific performance. Any shape of a reflecting surface may be used, although preferably it is produced by rotating a curve around the axis of symmetry of the desired reflector.

Reflecting surfaces provided in the embodiments of the present invention may be manufactured of glass, high quality plastic materials or metal. In the case of a solid piece of transparent material, reflective surfaces may be effected by applying reflective coatings on surfaces exterior to the solid transparent material. In the case of a transparent hollow housing, reflective surfaces may be fabricated by applying reflective coatings onto interior or exterior surfaces. Transparent optical lenses, or any transparent optical component in the described systems, may be made of high quality glass or plastic material that have appropriate optical properties such as but not limited to transparency, homogeneity, refraction index, etc.

All optical elements noted in the embodiments of the present invention, including reflecting surfaces and lenses are preferably matched in order to produce sharp images. Specific applications, configurations, and observation/detection ranges influence a correct matching of the optical elements.

A wide variety of applications, based on component size, are envisaged for the described system. Possible applications include: endoscopy and other in-situ medical imaging applications, detection of aircraft in close proximity for flight safety and collision avoidance purposes in VFR flight conditions; detection of torch light or flares in search and rescue operations (at sea or by helicopters over land); laser aiming and beam steering; monitoring IR radiation from fire hot spots and/or fire detection; detection of activities in secure and closely guarded areas (safe deposit box rooms in banks, classified archives, etc), and; traffic monitoring and control at road junctions.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub combination.

It will be appreciated by persons skilled in the art that the present invention is not limited to what has been particularly shown and described hereinabove. Rather the scope of the present invention is defined by the appended claims and includes both combinations and sub combinations of the various features described hereinabove as well as variations and modifications thereof which would occur to persons skilled in the art upon reading the foregoing description.

1. An imaging apparatus comprising:
a. an axisymmetric form comprising a transparent lateral surface, a first end surface, and a second end surface;
b. a first lens positioned substantially perpendicular to and concentric with the axis of said axisymmetric form, to the side of said first end surface;
c. a second lens positioned substantially perpendicular to and concentric with the axis of said axisymmetric form, to the side of said second end surface; and,
d. an image acquiring device positioned substantially coaxially with said second lens and beyond said second lens with respect to said second end surface;
thereby to form a nearly spherical image at said image acquiring device.

2. Apparatus according to claim 1 wherein said second end surface is symmetrically concave and comprises a reflecting layer and a transparent, non-reflecting central circular segment, said segment being located to allow light to pass primarily axially through said central circular segment and through said axisymmetric form.

3. Apparatus according to claim 1 wherein said first end surface comprises a circular reflective layer with a transparent, non-reflective central circular area, said non-reflective central circular area being located to allow light to pass substantially axially through said axisymmetric form and through said central circular segment.

4. Apparatus according to claim 3, wherein said circular reflective layer is substantially flat.

5. Apparatus according to claim 2 wherein said second end surface and said first end surface are mutually configurable to enable light from at least one object located substantially lateral to said axisymmetric form to pass into said axisymmetric form, to reflect from said second end surface, then to pass within said axisymmetric form and to reflect from said first end surface, and then to pass through said central circular segment in said second end surface.

6. Apparatus according to claim 1 wherein said first lens comprises a plurality of lenses.

7. Apparatus according to claim 3 wherein said first lens is located with respect to said axisymmetric form to enable light from an object located substantially axially exterior from said first end surface to be focused onto said image acquiring device.

8. Apparatus according to claim 1 wherein said second lens comprises a plurality of lenses.

9. Apparatus according to claim 1 wherein said second lens is configured to enable focusing of light passing from said axisymmetric form through said central circular segment, onto said image acquiring device.

10. Apparatus according to claim 1 wherein said image acquiring device is a camera.

11. Apparatus according to claim 1 wherein said first end surface comprises a circular reflective layer with a transparent, non-reflective central circular area, said non-reflective central circular area being located to allow light to pass substantially axially through said axisymmetric form and through said central circular segment to said image acquiring device, and wherein said second end surface and said first end surface are mutually configurable to enable light from at least one object located substantially lateral to said axisymmetric form to pass into said axisymmetric form, to reflect from said second end surface, then to pass within said axisymmetric form and to reflect from said first end surface, and then to pass through said central circular segment in said second end surface to said image acquiring device, thereby yield an uncorrected image of substantially circular shape comprising a central image part and a toroidal image part.

12. Apparatus according to claim 11 wherein said first end surface is substantially flat.

13. Apparatus according to claim 11 wherein said first end surface is substantially convex.

14. Apparatus according to claim 11 wherein said first end surface is substantially concave.

15. Apparatus according to claim 11 wherein said central image part comprises direct light from objects located primarily axially to said axisymmetric form and wherein said toroidal image part comprises doubly reflected light from objects located primarily laterally to said axisymmetric form.

16. Apparatus according to claim 15 wherein details of said central image part and said toroidal image part are of the same orientation.

17. An apparatus according to claim 11 further comprising an image transformer for transforming said uncorrected image into a predetermined format for viewing.

18. An apparatus according to claim 17 wherein said predetermined format is at least one from a list comprising rectangular, cylindrical, and spherical formats.

19. Apparatus according to claim 1 wherein said first lens is incorporated into said first end surface.

20. Apparatus according to claim 1 wherein said image acquiring device comprises an optical filter and a light sensing device, and wherein said optical filter is positioned before said light sensing device.

21. Apparatus according to claim 20 wherein said light sensing device is a focal plane array.

22. Apparatus according to claim 21 wherein said focal plane array is a CCD.

23. Apparatus according to claim 1 wherein said transparent lateral surface is transparent for at least one predetermined wavelength.

24. Apparatus according to claim 1 wherein said first lens is transparent for at least one predetermined wavelength.

25. Apparatus according to claim 1 wherein said axisymmetric form and said lenses are manufactured from any one of a group of materials comprising optic glass and optic plastic, said materials being selected to ensure optical properties including transparency, homogeneity, and index of refraction.

26. Apparatus according to claim 2 wherein said concave symmetrical surface is chosen from a family of axisymmetric shapes defined by rotating a curve around an axis of symmetry.

27. Apparatus according to claim 26 wherein said concave symmetrical surface is a hemisphere.

28. Apparatus according to claim 26 wherein said concave symmetrical surface is a paraboloid.

29. Apparatus according to claim 26 wherein said concave symmetrical surface is a cone.

30. Apparatus according to claim 1 wherein said axisymmetric form is chosen from a family of axisymmetric shapes defined by rotating any one of a plurality of curves around an axis of symmetry.

31. Apparatus according to claim 30 wherein said axisymmetric form is a cylinder.

32. Apparatus according to claim 30 wherein said axisymmetric form is a sphere.

33. Apparatus according to claim 30 wherein said axisymmetric form is a spheroid.

34. Apparatus according to claim 30 wherein said axisymmetric form is either one of a group chosen from a list of variant cylindrical forms comprising a cylinder with a convex lateral surface and a cylinder with a concave lateral surface.

35. Apparatus according to claim 1 wherein said axisymmetric form comprises a hollow axisymmetric shape.

36. Apparatus according to claim 35 wherein a wall thickness of said hollow axisymmetric shape is chosen to ensure predetermined diffraction coefficient properties.

37. Apparatus according to claim 35 wherein material of said hollow axisymmetric shape is chosen to ensure predetermined wavelength selectivity.

38. Apparatus according to claim 35 wherein at least one of said first surface and said second surface is removably attached to said hollow axisymmetric shape.

39. Apparatus according to claim 2 wherein said axisymmetric form comprises a hollow axisymmetric shape and said reflective layer comprises a reflective coating interior to said hollow axisymmetric shape.

40. Apparatus according to claim 2 wherein said axisymmetric form comprises a hollow axisymmetric shape and said reflective layer comprises a reflective coating exterior to said hollow axisymmetric shape.

41. Apparatus according to claim 3 wherein said axisymmetric form comprises a hollow axisymmetric shape and said reflective layer comprises a reflective coating interior to said hollow axisymmetric shape.

42. Apparatus according to claim 3 wherein said axisymmetric form comprises a hollow axisymmetric shape and said reflective layer comprises a reflective coating exterior to said hollow axisymmetric shape.

43. Apparatus according to claim 5 wherein said axisymmetric form comprises a solid monolithic form.

44. Apparatus according to claim 43 wherein said solid monolithic form is constructed of a material to ensure predetermined wavelength selectivity.

45. Apparatus according to claim 43 wherein said solid monolithic form is constructed of a material selected to ensure predetermined diffraction coefficient properties.

46. Apparatus according to claim 43 wherein respective reflective surfaces comprise reflective coatings applied exterior to said solid monolithic form

47. Apparatus according to claim 20 wherein said image light sensing device is controllably connected to a registration controller to enable radial and axial registration of a detected illuminator source relative to said axisymmetric form.

48. Apparatus according to claim 47 further comprising a source location mechanism, associated with said controller, operable to align said imaging acquiring device with true north and to translate said radial and axial registration into azimuth and elevation information.

49. An apparatus according to claim 48 wherein said source location mechanism is further operable to:
move said imaging acquiring device a known distance from an initial location to a new location,
set said imaging acquiring device to view said illuminator source and to determine new location azimuth and elevation information; thereby to determine a range of an illumination source,
said source location mechanism further comprising a triangulation device to triangulate said illuminator source range using said initial location and said new location azimuth and elevation information with said determined range, thereby to determine a location of said illuminator source.

50. An apparatus according to claim 48 wherein a range of said illuminator source is determinable using a range finder positionable in substantially close proximity to said imaging acquiring device.

51. A spherical illuminator source location apparatus comprising two illuminator detection devices respectively comprising:
a. an axisymmetric form comprising a lateral surface, a first end surface, and a second end surface;
b. a first lens positioned substantially perpendicular to and concentric with the axis of said axisymmetric form, to the side of said first end surface;
c. a second lens positioned substantially perpendicular to and concentric with the axis of said axisymmetric form, to the side of said second end surface; and,
d. an image acquiring device positioned substantially coaxially with said second lens and beyond said second lens with respect to said second end surface;
said apparatus further comprising a controller, operatively connected to each illuminator detection device, to coordinate measurements of respective illuminator detection devices of an illuminator source to determine a location of said illuminator source.

52. An apparatus according to claim 51 wherein respective illuminator detection devices are positionable a fixed distance from each other for viewing an illuminator source.

53. An apparatus according to claim 52 wherein said controller is operable to coordinate registering respective radial and axial coordinates of said illuminator source; to align respective initial coordinates with true north; to translate said respective radial and axial coordinates into respective azimuth and elevation information; and to triangulate using said fixed distance and respective azimuth and elevation information to obtain a range of said illuminator source.

54. A method for measuring a direction of an illumination source comprising:
a. imaging said illumination source, within a spherical view, using a unified optical apparatus,
b. registering radial and axial coordinates of said illumination source;
c. aligning with true north; and
d. translating said radial and axial coordinates into azimuth and elevation information.

55. A method according to claim 54 comprising determining a range of said illumination source by:
a. moving a known distance from an initial measuring location to a new location;
b. imaging said illumination source, within a spherical view, using a unified optical apparatus;
c. registering new radial and axial coordinates of said detected illumination source;
d. aligning initial coordinates of the new location with true north;
e. translating said new radial and axial coordinates into new azimuth and elevation information; and
f. triangulating by using said new azimuth and elevation information, said initial location determined azimuth and elevation information, and said known distance.

56. A method according to claim 54 comprising determining said illumination source range using a rangefinder located substantially adjoining said unified optical apparatus to measure a range to said illuminator source.
